(19) United States
(12) Patent Application Publication
(10) Pub. No.: US 2007/0195196 A1
(43) Pub. Date: Aug. 23, 2007

(54) Radar

(75) Inventors: Weng Keen Lam, Singapore (SG); Bing Bing Wang, Singapore (SG); Teck Khoon Ng, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,417

(22) PCT Filed: Dec. 6, 2004
(86) PCT No.: PCT/IB04/52669

§ 371 Date: Jun. 13, 2006

(30) Foreign Application Priority Data
Dec. 16, 2003 (EP) 03104733.5

(51) Int. Cl. H04N 5/45

(52) U.S. Cl. 348/565

(57) ABSTRACT

A video display device comprising a display to display a primary image, originating from a first input signal, and a picture-in-picture (PIP) overlaying the primary image and originating from a second input signal. The display characteristics of the PIP are changed in response to information, preferably a file extension, relating to the type of the first input signal in order to obscure as little as possible of the important parts of the primary image. In case the primary image contains much visual information the PIP is chosen small, positioned in the periphery of the display and/or transparent. In case the primary image contains little visual information the PIP is chosen large, centered and/or non-transparent. Useful for Integrated Digital TV cum Broadband TV (IDTV-BBTV) devices, where the primary image is a broadband image and the PIP is a TV image.

### FIELD OF THE INVENTION

The present invention relates to a video display device. More particularly, the present invention relates to a video display device which is adapted to display a primary image and a picture-in-picture (PIP) overlaying the primary image. The present invention furthermore relates to a method of controlling a PIP display characteristic in the video display device.

### BACKGROUND OF THE INVENTION

US patent application No. US 2002/0075407 discloses a video display device having a picture-in-picture (PIP) display and a processor. The processor detects cues, such as color, texture, events, behaviors, etc., present in a primary display image, that is overlaid by the PIP. These cues are utilized by the processor to determine important and relatively unimportant portions of the primary image. Based on this information, the processor may change characteristics of the PIP so as to obscure less of an important portion of the primary image by the PIP. Display characteristics that may be changed by the processor include the PIP position, size and transparency.

However, the task of determining important and relatively unimportant portions of the primary image may be rather difficult and complex.

### SUMMARY OF THE INVENTION

Thus, it is an object of the present invention to provide a video display device being capable of changing the characteristics of a PIP in order to avoid obscuring important parts of the primary image in a simple and easy manner.

It is a further object of the present invention to provide a method of controlling a PIP display characteristic in a video display device in a simple and easy manner.

According to a first aspect of the present invention the above and other objects are fulfilled by providing a video display device comprising:

a display adapted to display a primary image and a picture-in-picture (PIP) overlaying the primary image,

first input means adapted to receive a first input signal, said first input signal defining said primary image, and said first input signal comprising information relating to the type of said first input signal,

second input means adapted to receive a second input signal, said second input signal defining said PEP,

a processor operatively coupled to the display and to the first and second input means, said processor being adapted to analyze the information relating to the type of the first input signal and to change a PIP display characteristic in response to said information.

According to a second aspect of the present invention the above and other objects are fulfilled by providing a method of controlling a picture-in-picture (PIP) display characteristic in a video display device comprising a display and a processor being operatively coupled to the display, the method comprising the steps of:

receiving a first input signal, said first input signal defining a primary image to be displayed on the display, and said first input signal comprising information relating to the type of said first input signal,

receiving a second input signal, said second input signal defining said PIP, analyzing, by means of said processor, the information relating to the type of the first input signal, and

changing a PIP display characteristic in response to said information.

According to a third aspect of the present invention the above and other objects are fulfilled by providing a computer program being adapted to perform the method steps defined in the second aspect of the present invention when running on a general purpose computer.

The processor may be any suitable kind of processor, e.g. embedded in the video display device or located in an external computer device, e.g. a personal computer (PC), which is connected to the video display device.

The primary image is preferably an image which the viewer whishes to watch on the display. It may be a game, internet contents, a video image, a TV image etc. It may alternatively be a random signal or a screen saver in case the first input signal is a pure audio signal, such as music.

The PIP is a picture which overlays the primary image. According to the present invention it is possible to easily choose, e.g. the size or position of the PIP in the primary image in such a way that the primary image is minimally disturbed by the PIP. Thus, based on a simple analysis of the type of the first input signal, the display characteristics (e.g. the size and/or position) of the PIP may be changed in order to optimize the utilization of the display. Thus, it may be ensured that as little as possible of the ‘important’information of the primary image is obscured by the PIP. Also, in case the primary image contains little or no visible information (e.g. in case the first signal is a pure audio signal, such as a radio signal), the PIP may obtain a prominent position on the display.

Since information relating to the type of the first input signal is easily obtainable, the display characteristics of the PIP may be easily changed based on this. Thus, no heavy or difficult calculations or assessments are necessary in order to determine whether or not the display characteristics need to be changed, and, if so, in which way.

Preferably, the first input signal comprises at least one file, in which case the information may comprise information relating to a file extension of the first signal. Thus, in this embodiment the type of the first input signal is determined on the basis of a file extension. This is very easily obtainable from e.g. a broadband signal received via the Internet or originating from a server device being separate from the video display device. Alternatively, the information relating to the type of the first input signal may be derived from the signal in another manner.

The PIP display characteristic may be at least one of a position of the PIP on the display, a display size of the PIP, and a transparency of the PIP.

The first and/or the second input signal may be a broadband signal and/or a TV signal. In a preferred embodiment the first input signal is a broadband signal, such as a signal received via the Internet or via a link from a separate computer device, and the second input signal is a TV signal, such as an analog TV signal, a digital TV signal or a Teletext signal. The broadband signal may e.g. be a game, Internet information, music, video, still pictures (such as a photograph), etc. In case the first input signal is a game, a video signal or the like, the PIP is preferably chosen to be small and/or transparent and positioned away from important parts (e.g. the center part) of the primary image. In case the first input signal is a pure audio signal (e.g. a radio signal or another music signal), the PIP may be given a prominent position and size on the display, e.g. positioned in the middle of the display with a large, non-transparent image. In this case the PIP may be used instead of a screen saver.

Alternatively or additionally, the first and/or the second input signal may be an Audio-Video (AV) signal. In this case the signal(s) is/are preferably received from a legacy device, such as a DVD player. Furthermore, the first and/or the second input signal may be an FM radio signal.

The video display device is preferably an Integrated Digital TV device.

### BRIEF DESCRIPTION OF THE DRAWINGS

The invention will now be further described with reference to the accompanying drawings, in which

FIG. 1 is an illustration of an Integrated Digital TV cum Broadband TV device with the present invention,

FIG. 2 shows a display with a primary image and a PIP in an inferior position, and

FIG. 3 shows a display with a primary image and a PIP in a prominent position.

### DESCRIPTION OF PREFERRED EMBODIMENTS

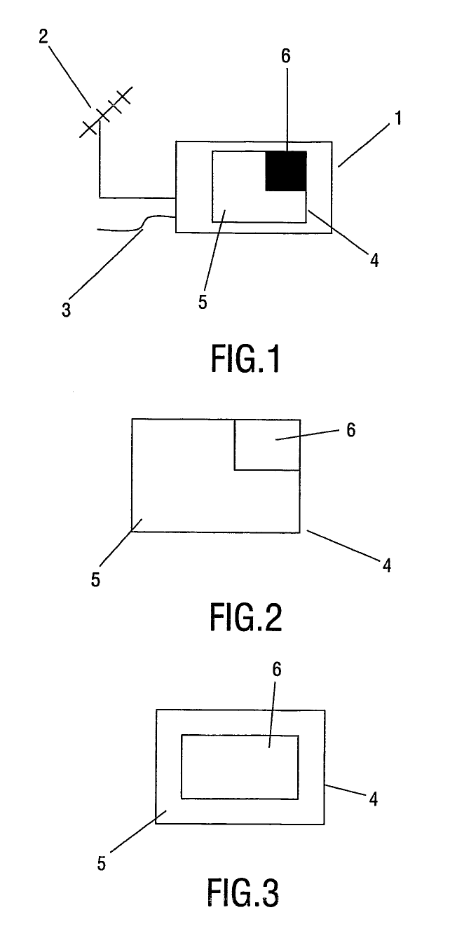

FIG. 1 is an illustration of an Integrated Digital TV cum Broadband TV (IDTV-BBTV) device 1 being adapted to receive analog or digital TV via antenna 2. Furthermore, the IDTV-BBTV device 1 is connected to the Internet and/or to a separate personal computer (PC) via connection 3. The IDTV-BBTV device 1 comprises a display 4 onto which a primary image 5 and a PIP 6 may be imaged.

A broadband signal is received via the connection 3, and this broadband signal defines the primary image 5. Simultaneously a TV signal is received via the antenna 2, and this TV signal defines the PIP 6. Even though FIG. 1 shows that the TV signal is received via an antenna 2, it should be understood that the TV signal could be received in any other suitable manner, e.g. from a legacy device, such as a DVD player, etc. Information relating to the type of the broadband signal is derived from the signal, e.g. from a file extension of at least one file in the broadband signal. Based on this information the display characteristics of the PIP 6 is changed in order to ensure that important parts of the primary image 5 are not obscured by the PIP 6. The derived information relating to the type of the broadband signal thus indicates where and to what extend important areas of the primary image 5 are present. Hence it indicates where and how the PIP 6 may be positioned in order to disturb the primary image 5 as little as possible.

FIG. 2 shows a display 4 with a primary image 5 and a PIP 6 in an inferior position. Thus, the PIP 6 is small and located in the upper right corner of the display 4, thereby obscuring only a small (and presumably less important) part of the primary image 5. Furthermore, the PIP 6 may be chosen to be transparent, thereby obscuring even less of the primary image 5. Even though FIG. 2 shows that the PIP 6 is located in the upper right corner of the display 4, it should be understood that this is just an example, and that the position of the PIP 6 is chosen in such a way that as little as possible of the ‘important’ parts of the primary image 5 is obscured by the PIP 6.

The situation in FIG. 2 will typically occur when the type of the broadband signal indicates that the broadband signal is of a kind with dominant visual contents, e.g. a video signal, a still picture, a game, etc. In this case it is desirable to maintain a relatively large part of the primary image 5 undisturbed by the PIP 6.

FIG. 3 shows a display 4 with a primary image 5 and a PIP 6 in a prominent position. Thus, the PIP 6 is positioned in a center part of the display 4 and almost covering the primary image 5.

The situation in FIG. 3 will typically occur when the type of the broadband signal indicates that the broadband signal contains no or only very little visual information, e.g. a radio signal or another kind of music signal. In this case the PIP 6 may advantageously cover a large part of the primary image 5, and it may even replace a screen saver or the like.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality.

1. A video display device (1) comprising:
a display (4) adapted to display a primary image (5) and a picture-in-picture (PIP) (6) overlaying the primary image (5),
first input means (3) adapted to receive a first input signal, said first input signal defining said primary image (5), and said first input signal comprising information relating to the type of said first input signal,
second input means (2) adapted to receive a second input signal, said second input signal defining said PIP (6),
a processor operatively coupled to the display (4) and to the first (3) and second (2) input means, said processor being adapted to analyze the information relating to the type of the first input signal and to change a PIP display characteristic in response to said information.

2. A video display device (1) according to claim 1, wherein the first input signal comprises at least one file, and wherein the information comprises information relating to a file extension of the first signal.

3. A video display device (1) according to claim 1, wherein the PIP display characteristic is at least one of a position of the PIP (6) on the display (4), a display size of the PIP (6), and a transparency of the PIP (6).

4. A video display device (1) according to claim 1, wherein the first and/or the second input signal is a broadband signal.

5. A video display device (1) according to claim 1, wherein the first and/or the second input signal is a TV signal.

6. A video display device (1) according to claim 1, wherein the first and/or the second input signal is an Audio-Video (AV) signal.

7. A video display device (1) according to claim 1, wherein the video display device (1) is an Integrated Digital TV device.

8. A method of controlling a picture-in-picture (PIP) display characteristic in a video display device (1) comprising a display (4) and a processor being operatively coupled to the display (4), the method comprising the steps of:
receiving a first input signal, said first input signal defining a primary image (5) to be displayed on the display (4), and said first input signal comprising information relating to the type of said first input signal,
receiving a second input signal, said second input signal defining said PIP (6), analyzing, by means of said processor, the information relating to the type of the first input signal, and
changing a PIP display characteristic in response to said information.

9. A computer program being adapted to perform the method steps of claim 7 when running on a general purpose computer.
